(19) United States
(12) Patent Application Publication
(10) Pub. No.: US 2016/0378223 A1
(43) Pub. Date: Dec. 29, 2016

(54) DETECTION SENSOR AND DETECTION SENSOR FABRICATION METHOD

(71) Applicant: SHIN-ETSU POLYMER CO., LTD., Tokyo (JP)

(72) Inventors: Shunta HYUGA, Saitama (JP); Kimihiko WATANABE, Saitama (JP)

(21) Appl. No.: 15/103,149

(22) PCT Filed: Dec. 15, 2014
(86) PCT No.: PCT/JP2014/006226

§ 371 Date: Jun. 9, 2016

(30) Foreign Application Priority Data
Dec. 18, 2013 (JP) 2013-260744

(51) Int. Cl. G06F 3/044; G06F 3/0354; G06F 3/02; G06F 3/041

(52) U.S. Cl. CPC G06F 3/044; G06F 3/0416; G06F 3/03547; G06F 3/0202; G06F 2203/04103

(57) ABSTRACT

There is provided a technology making it possible to improve operability and reliability of a detection sensor. A detection sensor detecting a pressing state on an operation surface in a pressing direction, includes: a first electrode layer and a second electrode layer both configured to detect variation in electrostatic capacitance; and a displacement layer provided between the first electrode layer and the second electrode layer, the displacement layer being adapted to vary a distance between the first electrode layer and the second electrode layer in response to pressing of the operation surface, in which the displacement layer includes a rubbery elastic body and includes a plurality of columnar parts each stretchable in the pressing direction, one or both of a surface of the first electrode layer facing the displacement layer and a surface of the second electrode layer facing the displacement layer are provided with a bonding layer that is configured of a rubbery elastic layer or a coating layer containing a silane compound, and the columnar parts are integrally bonded to the bonding layer.

### CROSS REFERENCE TO RELATED APPLICATIONS

The present application is a U.S. national phase of application No. PCT/JP2014/006226, filed on Dec. 15, 2014, which is based upon and claims the benefit of priority of the Japanese Patent Application No. 2013-260744 filed in the Japan Patent Office on Dec. 18, 2013, the entire contents of which are incorporated herein by reference. Furthermore, the entire contents of all patents, published patent applications, and other references cited herein are hereby expressly incorporated herein by reference.

### TECHNICAL FIELD

The present invention relates to a detection sensor detecting operation on an operation surface in a pressing direction, and to a detection sensor fabrication method.

### BACKGROUND ART

In related art, an input device using pressing button switches such as a keyboard is known as one for an electronic apparatus. The input device using the pressing button switches detects two states, an ON state and an OFF state.

In contrast, a detection member that includes a plurality of electrodes disposed on a base substance that is deformed by pressing, and detects displacement in the pressing direction, based on variation of an electrostatic capacitance between the electrodes is known (for example, see Patent Literature 1).

### CITATION LIST

### Patent Literature

Patent Literature 1: Japanese Patent Laid-Open No. 2011-17626

### SUMMARY OF INVENTION

### Technical Problem

For example, as disclosed in Patent Literature 1, when a base substance of a plate elastic member is used for an electrostatic capacitance type detection member, the base substance is present on an entire spaces between the electrodes. Therefore, large resistance force may occur with respect to the pressing, which makes it difficult to perform pressing, and operability may be accordingly impaired in some cases. In addition, the base substance is expanded in a lateral direction when being pressed, which may disadvantageously cause the base substrate to run over from an original occupied region of the detection member in the lateral direction. It is necessary to consider expansion of the base substance in arrangement of the detection member.

In contrast, when a base substance having a foamed structure, such as a sponge rubber, is used, it is possible to reduce the resistance force with respect to the pressing; however, the base substance takes time to return to its original state after deforming by pressing, which disadvantageously impairs responsiveness and operability. In addition, in the detection member, in the case where light transmission or light scattering is performed to apply light to letters and characters, the sponge rubber may adversely affect the light transmission and the light scattering.

Further, the detection member is desired to have reliability to constantly detect displacement in the pressing direction accurately.

In addition, an electrostatic capacitance detected by the detection member is proportional to a dielectric constant of a substance interposed between electrodes and is inversely proportional to a distance between the electrodes. Therefore, a fixed dielectric constant of the interposed substance and a small thickness of the interposed substance are required. Further, when the detection member is not pressed, it is necessary to constantly and stably maintain the distance between the electrodes with high accuracy. In addition, it is necessary for the detection member to be easily pressed.

As with Patent Literature 1, however, when the material having air spaces such as a sponge is used as the substance between the electrodes, the dielectric constant of the material is varied depending on a foamed state of the material, which makes it difficult to maintain a fixed dielectric constant. Further, the dielectric constant is also varied due to moisture absorption of the sponge, which also makes it difficult to maintain the fixed dielectric constant.

In addition, the detection member may be required to be reduced in thickness in some cases because the detection member is used in, for example, a personal computer and a mobile terminal. Also, the detection member is required to have a high dimension accuracy between an upper electrode and a lower electrode in order to appropriately detect variation of the electrostatic capacitance.

The present invention is provided to solve the above-described disadvantages, and it is an object of the present invention to provide a technology making it possible to improve operability and reliability of the detection member.

### Solution to Problem

To achieve the above-described object, a detection sensor according to an embodiment of the present invention is a detection sensor configured to detect a pressing state on an operation surface in a pressing direction, and the detection sensor includes: a first electrode layer and a second electrode layer both configured to detect variation in electrostatic capacitance; and a displacement layer provided between the first electrode layer and the second electrode layer, the displacement layer being adapted to vary a distance between the first electrode layer and the second electrode layer in response to pressing of the operation surface, in which the displacement layer includes a rubbery elastic body and includes a plurality of columnar parts each stretchable in the pressing direction, one or both of a surface of the first electrode layer facing the displacement layer and a surface of the second electrode layer facing the displacement layer are provided with a bonding layer that is configured of a rubbery elastic layer or a coating layer containing a silane compound, and the columnar parts are integrally bonded to the bonding layer.

In a detection sensor according to another embodiment, easy adhesion treatment is intensively performed on bonding surfaces of the columnar parts to be bonded to the bonding layer and/or a bonding surface of the bonding layer to be bonded to the columnar parts to integrally bond the columnar parts to the bonding layer.

In a detection sensor according to another embodiment, the columnar parts and the bonding layer are overlapped to be integrally bonded to each other after application of ultraviolet rays, plasma treatment, or corona treatment is performed on the respective bonding surfaces.

In a detection sensor according to another embodiment, the columnar parts each have a circular-column shape or a truncated cone shape.

In a detection sensor according to another embodiment, the displacement layer includes a plate layer formed of a rubbery elastic body, and the columnar parts are formed integrally with the plate layer.

In a detection sensor according to another embodiment, the bonding layer is provided only in a partial region including a region corresponding to the bonding surfaces of the plurality of columnar parts, on one or both of the surface of the first electrode layer facing the displacement layer and the surface of the second electrode layer facing the displacement layer.

In a detection sensor according to another embodiment, the displacement layer includes, in a peripheral part, a wall part to shield inflow of air into the displacement layer from surroundings.

In a detection sensor according to another embodiment, the first electrode layer includes a drive electrode to which a voltage is applied, to detect variation in electrostatic capacitance, and the second electrode layer includes a receiving electrode generating a current corresponding to the distance between the first electrode layer and the second electrode layer.

In a detection sensor according to another embodiment, the rubbery elastic body is silicone rubber.

A detection sensor fabrication method according to another embodiment of the present invention is a detection sensor fabrication method of fabricating a detection sensor configured to detect pressing operation of an operation surface in a pressing direction, the detection sensor includes a first electrode layer and a second electrode layer both configured to detect variation in electrostatic capacitance, and a displacement layer provided between the first electrode layer and the second electrode layer, the displacement layer being adapted to vary a distance between the first electrode layer and the second electrode layer in response to pressing of the operation surface, the displacement layer including a rubbery elastic body and including a plurality of columnar parts each stretchable in the pressing direction, one or both of a surface of the first electrode layer facing the displacement layer and a surface of the second electrode layer facing the displacement layer being provided with a bonding layer that is configured of a rubbery elastic layer or a coating layer containing a silane compound, and the method includes: an easy adhesion treatment step of performing easy adhesion treatment on one or both of a surface of the bonding layer to be bonded to the columnar parts and surfaces of the columnar parts to be bonded to the bonding layer; and a step of overlapping the bonding layer with the columnar parts to integrally bond the bonding layer to the columnar parts after the easy adhesion treatment step.

In a detection sensor fabrication method according to another embodiment, the easy adhesion treatment step is a step of performing the easy adhesion treatment intensively on the bonding surfaces of the columnar parts to be bonded to the bonding layer and/or the bonding surface of the bonding layer to be bonded to the columnar parts.

In a detection sensor fabrication method according to another embodiment, the easy adhesion treatment step is performed with use of a masking jig that exposes top surfaces of the columnar parts and/or a part or whole of the bonding surface of the bonding layer to be bonded to the top surfaces of the columnar parts.

### Advantageous Effects of Invention

According to the present invention, it is possible to improve operability and reliability of the detection sensor.

### BRIEF DESCRIPTION OF DRAWINGS

FIG. 1 is a sectional diagram of a detection sensor according to a first embodiment of the present invention.

FIG. 2 is a sectional diagram of a detection sensor according to a second embodiment of the present invention.

FIG. 3 is a diagram for explaining a method of fabricating the detection sensor according to the second embodiment of the present invention.

FIG. 4 is an electron microscope photograph of a surface of a columnar part and a surface of a rubbery elastic layer of the detection sensor according to the second embodiment of the present invention after peeling the columnar part and the rubbery elastic layer of the detection sensor.

FIG. 5 is a sectional diagram of a detection sensor according to a modification of the present invention.

FIG. 6 is a plan view (6A) of a masking jig used in fabricating a detection sensor according to a third embodiment of the present invention, an A-A enlarged sectional diagram (6B) illustrating a region near one of a plurality of through holes provided in the masking jig, and an enlarged sectional diagram (6C) illustrating a state in which columnar parts are inserted into the respective through holes of the masking jig and easy adhesion treatment is performed on top surfaces thereof in the same field of view as (6B).

FIG. 7 illustrates some modifications of the masking jig of FIG. 6.

FIG. 8 is an enlarged sectional diagram (8A) illustrating a state where the masking jig of (7A) of FIG. 7 is upside down and the columnar parts are inserted into the respective through holes from expanded-diameter parts of the respective through holes, and an enlarged sectional diagram (8B) illustrating another usage example of the masking jig.

FIG. 9 is a diagram for explaining a method of fabricating a detection sensor in which a top surface of a rubbery elastic layer serving as a bonding layer to be bonded to the columnar parts is smaller in area than a top surface of each columnar part.

FIG. 10 illustrates comparison of superiority between cases where the columnar parts are bonded to the bonding layer through the above-described various kinds of bonding methods.

### DESCRIPTION OF EMBODIMENTS

Some embodiments of the present invention are described with reference to drawings. Note that embodiments described below are not intended to limit the invention according to the claims, and all features and combinations described in the embodiments are not necessarily essential to solution means of the invention.

### First Embodiment

First, a detection sensor according to a first embodiment of the present invention is described.

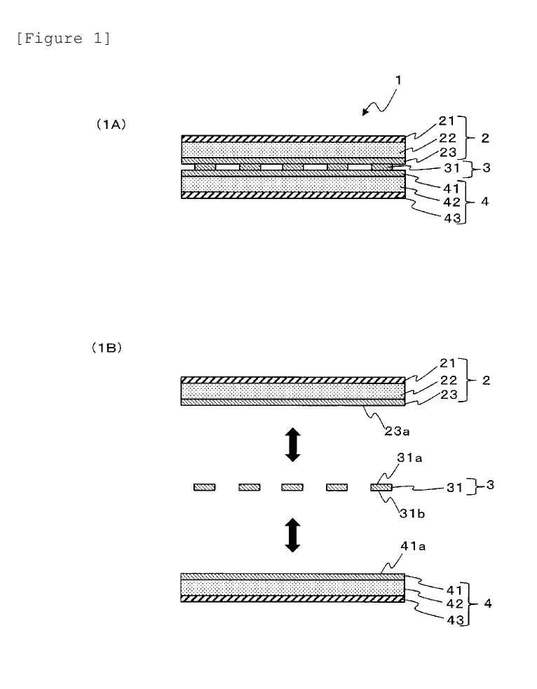

FIG. 1 is a sectional diagram of the detection sensor according to the first embodiment of the present invention. (1A) is a sectional diagram of the detection sensor, and (1B) is a diagram for explaining a method of fabricating the detection sensor.

A detection sensor 1 is a sensor detecting pressing operation in a pressing direction (in the figure, in a vertical direction: hereinafter, also referred to as a Z direction), and includes a first electrode layer 2, a displacement layer 3, and a second electrode layer 4 in order from operation surface side (upper side in the figure).

The first electrode layer 2 includes an electrode 21, a base film 22, and a rubbery elastic layer 23 in order from the operation surface side. A thickness of the first electrode layer 2 may be preferably 0.01 mm or more and 1 mm or less, and more preferably 0.01 mm or more and 0.4 mm or less because it is necessary for the first electrode layer 2 to deform when the operation surface is pressed.

For example, the electrode 21 is a drive electrode to which a voltage is applied from an unillustrated power supply. The electrode 21 may be configured of a metal thin film such as copper and silver, and may be configured of a conductive polymer film such as a transparent PEDOT/PSS, a film formed of nanosized micro fibers such as copper, silver, and carbon, or an ITO (indium tin oxide) film. The electrode 21 has a thickness of, for example, 0.01 μm or more and 1 μm or less in the Z direction. The reason why the thickness of the electrode 21 in the Z direction is set as described above is because, when the thickness of the electrode 21 in the Z direction is set to be lower than 0.01 μm, resistance is high and an electrostatic capacitance is not detected accurately. In addition, when the thickness of the electrode 21 in the Z direction is set to 1 μm or more, the electrode is excessively thick and is hardened, which makes the first electrode layer 2 difficult to deform when the detection sensor is pressed. The first electrode layer 2 is not uniformly deformed depending on the shape of the electrode.

The base film 22 is formed of, for example, a resin film high in insulation property and excellent in flexibility, and is suitably formed of polyethylene terephthalate (PET), polycarbonate (PC), or polymethyl methacrylate (PMMA). As the base film 22, for example, S10 commercially available from Toray Industries, Inc. may be used. Physical or chemical surface treatment may be performed on a surface of the resin film forming the base film 22.

The rubbery elastic layer 23 is an example of a bonding layer. Examples of a rubbery elastic body forming the rubbery elastic layer 23 may include: thermosetting elastomer such as urethane rubber, isoprene rubber, ethylene-propylene rubber, natural rubber, ethylene-propylene-diene rubber, styrene-butadiene rubber, and silicone rubber; urethane-based, ester-based, styrene-based, olefin-based, butadiene-based, and fluorine-based thermoplastic elastomer; and composites thereof. Silicone rubber that is relatively small in dimension change in response to repeated pressing, namely, relatively small in compression set and contains a siloxane bond is suitable for the rubbery elastic body because consistent relationship between pressing force and an interelectrode distance depending on the pressing force is particularly important. The rubbery elastic body forming the rubbery elastic layer 23 may be subjected to primary vulcanization or secondary vulcanization. Also, the rubbery elastic body may be colored. As the rubbery elastic layer 23, silicone rubber generated with use, as a raw material, of X-34-1802A/B (with rubber hardness A of 15 to 35) or X-32-2170A/B (with rubber hardness A of 10 to 25) commercially available from Shin-Etsu Chemical Co., Ltd. may be used. Here, the rubber hardness A means type A durometer hardness in compliance with JISK6253 measurement method described later. Note that, as the bonding layer, a coating layer containing a silane compound may be used in place of the rubbery elastic layer 23. Examples of the coating layer containing a silane compound may include a silane coupling agent layer and a siloxane-based coating layer. A kind of the silane coupling agent may be optional as long as the silane coupling agent is suitable for the base film 22. The silane coupling agent layer may be formed of KBE-903 commercially available from Shin-Etsu Chemical Co., Ltd., a primer material obtained by diluting one to two kinds of silane coupling agents with a solvent, or an aminosilane-based primer (for example, KBP-40 commercially available from Shin-Etsu Chemical Co., Ltd.).

Examples of the siloxane-based coating layer may include a coating layer in which linear chain dimethyl polysiloxane is cured and fixed on the surface of the base material through an optional method. The method of curing the coating agent of the coating layer may be a method of condensation reaction type or addition reaction type using heat, or a method using ultraviolet rays or electron beams. Also, a form of the coating agent may be of a solvent type, an emulsion type, or a solventless type. For example, as the coating agent, there is a peeling silicone agent of an addition reaction type in which a linear chain methylvinylpolysiloxane including a vinyl group in both terminals or in both terminals and a chain is reacted with methyl hydrogen polysiloxane in the presence of a platinum-based catalyst. Examples thereof may include KS-774 commercially available from Shin-Etsu Chemical Co., Ltd.

In addition, as the siloxane-based coating layer, monofunctional to tetrafunctional, in particular, trifunctional or tetrafunctional organopolysiloxane that is formed of a silicon atom coupled with an organic group using a siloxane bond as a skeleton may be used. For example, organopolysiloxane using colloidal silica as a tetrafunctional component may be used. As necessary, a bifunctional monomer may be introduced in order to impart flexibility or a silane coupling agent may be introduced in order to enhance adhesiveness or the like, into the coating agent. For example, as a siloxane-based hard coating agent, KP-85 commercially available from Shin-Etsu Chemical Co., Ltd. may be used.

As a material of the siloxane-based coating layer, a hydrophilic coating agent containing crystalline or amorphous silica, for example, a hydrophilic coating agent obtained by mixing amorphous silica, methanol, isopropyl alcohol, and the like may be used. As the hydrophilic coating agent, for example, EXCEL PURE commercially available from Central Automotive Products LTD. may be used.

The displacement layer 3 is formed of a rubbery elastic body, and includes a plurality of columnar parts 31 each stretchable in the Z direction. Each of the columnar parts 31 has, for example, a dot shape (for example, a circular-column shape or a truncated cone shape). When each of the columnar parts 31 is formed in the circular-column shape or the truncated cone shape, it is possible to uniformly distribute force from the upper surface to an entire circumferential direction unlike a case of a shape including a corner such as a prism. This makes it possible to reduce a risk of damage at specific positions of the columnar parts 31, thereby enhancing durability. In addition, when each of the columnar parts 31 has the truncated cone shape, as compared with the circular-column shape, filling property of an uncured material into a mold in formation of the columnar parts 31 with use of the mold, demolding operation in demolding of the cured columnar parts 31, and manufacturing yield become high. However, the shape of each columnar part 31 is not limited thereto, and the columnar parts 31 each may have any shape as long as an area enough to secure necessary adhesive strength is secured on a surface opposed to the other layer. The plurality of columnar parts 31 are arranged in the vertical and lateral directions in the top surface of the second electrode 4 with a pitch. The pitch between the columnar parts 31 may be preferably small in order to improve detection accuracy of displacement in the pressing direction. The columnar parts 31 each may be preferably formed of the same kind of the rubbery elastic body with hardness same as or different from the rubbery elastic layer 23. A height of each columnar part 31 may be, for example, 0.01 mm or more and 1 mm or less, and more preferably 0.01 mm or more and 0.3 mm or less. Also, a displacement of an electrode layer (in the present embodiment, the first electrode layer 2) on side displaced in response to contraction of the columnar parts 31 is, for example, within 80% of the height of each columnar part 31. As the columnar parts 31, for example, silicone rubber generated with use of, as a raw material, KE-1950-10A/B (with rubber hardness A of 10), KEG-2000-40A/B (with rubber hardness A of 40), KE-951-U and a vulcanizing material C-25A/B (with rubber hardness A of 50), KE-2090-60A/B (with rubber hardness A of 60), KE-981-U and a vulcanizing material C-25A/B (with rubber hardness A of 80), or the like that are commercially available from Shin-Etsu Chemical Co., Ltd., may be used. The columnar parts 31 may be formed using a mold or formed through printing, and preferably formed using a mold in terms of shape stability. The rubbery elastic body forming the columnar parts 31 is not limited to those mentioned above, and is optionally selectable. A vulcanization type and hardness of the rubbery elastic body forming the columnar parts 31 is optionally selectable. Also, the rubbery elastic body forming the columnar parts 31 may be colored as long as the detection sensor 1 does not require transmission of light. The columnar parts 31 and the rubbery elastic layer 23 are integrally bonded as described later. In addition, the columnar parts 31 and a rubbery elastic layer 41 are integrally bonded as described later.

The rubber hardness of the columnar parts 31 of the displacement layer 3 may be preferably 10 or more and 80 or less, and more preferably 25 or more and 80 or less in type A durometer hardness in compliance with JISK6253 measurement method. Also, the rubber hardness of each of the rubbery elastic layers 23 and 41 may be preferably 10 or more and 80 or less, and more preferably 10 or more and 70 or less in type A durometer hardness in compliance with JISK6253 measurement method. The rubber hardness of each of the rubbery elastic layers 23 and 41 may be preferably equivalent to or lower than the rubber hardness of the columnar parts 31 of the displacement layer 3.

As described later, the surface-treated columnar parts 31 of the displacement layer 3 and the surface of a counterpart to be bonded to the columnar parts 31 are both solid. Therefore, unless the surfaces are physically brought closer to each other, a contact area is not stable due to fine spaces interposed therebetween and OH groups on the respective surfaces form a hydrogen bond, which makes it difficult to perform integral bonding. Accordingly, as the rubber hardness of the columnar parts 31 is lower, the bonding is performed faster and more stably when the columnar parts 31 are pressed against the surface of the counterpart because the stress allows the columnar parts 31 to easily follow the surface of the counterpart. Further, the counterpart to be integrally bonded to the columnar parts 31 is each of the rubbery elastic layers 23 and 41 formed of a rubbery elastic body. The columnar parts 31 and each of the rubbery elastic layers 23 and 41 are mutually compressed and deformed, which easily decreases the distance at the interface, thereby providing such effects more surely.

Here, when the detection sensor 1 is pressed, the columnar parts 31 each having a certain thickness are compressed and elastically deformed to cause the detection sensor 1 to exert a detection function in the Z direction. However, when the rubber hardness of the columnar parts 31 is excessively low, the detection sensor 1 is not sufficient in strength and may be easily destroyed. On the other hand, when the rubber hardness of the columnar parts 31 is excessively high, the pressing force is necessary, thereby impairing operability. Further, when the density of the columnar parts 31 is sparse, the first electrode layer 2 is easily deflected in a region around the pressed part, thereby adversely affecting the operability. The rubbery elastic layers 23 and 41 are sufficiently thinner than the columnar parts 31, and therefore, influence thereof is small even if the rubber hardness of the rubbery elastic layers 23 and 41 is low. For example, when the rubbery elastic layers 23 and 41 each have the rubber hardness lower than that of the columnar parts 31, the surfaces are brought into close contact with each other in compression bonding, which provides easily fixable effect.

Surroundings of the columnar parts 31 of the displacement layer 3 is a clearance. When the operation surface is pressed, the columnar parts 31 are relatively easily contracted, and when the pressing of the operation surface is finished, the columnar parts 31 rapidly extend and go back to the original state. This improves responsiveness to the pressing of the detection sensor 1 and improves operability.

The second electrode layer 4 includes an electrode 43, a base film 42, and a rubbery elastic layer 41 in order away from the operation surface.

The electrode 43 is a receiving electrode to detect an electrostatic capacitance between the electrode 43 and the electrode 21. The electrode 43 may be formed of the same material as the electrode 21. The electrode 43 has a thickness of, for example, 0.01 nm or more and 1 mm or less in the Z direction. It is unnecessary for the electrode 43 to deform by pressing. Therefore, the constituent material and the thickness in the Z direction of the electrode 43 are not limited to those mentioned above.

The base film 42 is formed of, for example, a resin film high in insulation property and excellent in flexibility, and is suitably formed of polyethylene terephthalate (PET), polycarbonate (PC), or polymethyl methacrylate (PMMA). Physical or chemical surface treatment may be performed on a surface of the resin film forming the base film 42.

The rubbery elastic layer 41 is an example of the bonding layer, and is suitably formed of a material similar to that of the rubbery elastic layer 23. Note that, as the bonding layer, a silane coupling agent layer may be used in place of the rubbery elastic layer 41. The silane coupling agent layer may be formed of, for example, a material similar to that of the silane coupling agent layer in the first electrode layer 2 as long as the silane coupling agent is suitable for the base film 42.

Next, a method of fabricating the detection sensor according to the first embodiment is described.

As illustrated in (1B) of FIG. 1, the electrode 21 is formed on one of surfaces of the base film 22, and the rubbery elastic layer 23 is formed on the other surface to form the first electrode layer 2. To form the rubbery elastic layer 23 on the base film 22, for example, silicone rubber containing a component showing adhesiveness with respect to the base film 22 may be applied through screen printing.

Then, ultraviolet rays are applied to a bonding surface 23a of the first electrode layer 2 that is opposed to the columnar parts 31 of the displacement layer 3 and bonding surfaces 31a of the columnar parts 31 of the displacement layer 3 that are opposed to the first electrode layer 2. The ultraviolet rays to be applied are light having a wavelength equal to or lower than the wavelength of near-ultraviolet rays (having a wavelength of 200 nm or more and 380 nm or less), and are suitably light of far-ultraviolet rays or vacuum-ultraviolet rays (having a wavelength of 10 nm or more and 200 nm or less). In the present embodiment, for example, an excimer lamp that uses xenon as electric discharge gas to emit vacuum-ultraviolet rays (VUV) including a wavelength of 172 nm is used to apply light. Note that easy adhesion treatment such as vacuum plasma treatment, atmospheric pressure plasma treatment, corona treatment, and flame treatment may be performed on the bonding surface 23a and the bonding surfaces 31a without using the excimer lamp. This step corresponds to an easy adhesion treatment step of performing the easy adhesion treatment on one or both of a surface of the bonding layer to be bonded to the columnar parts and surfaces of the respective columnar parts to be bonded to the bonding layer.

When the plasma treatment or the corona treatment is performed, surrounding gas is ionized and the ionized gas is accelerated by virtue of the applied potential difference. The accelerated ionized gas then collides with the bonding surface 23a and the bonding surfaces 31a, intramolecular bonds of the bonding surface 23a and the bonding surfaces 31a are destroyed, and radical occurs on the surface of the bonding surface 23a and the surfaces of the bonding surfaces 31a. Then, oxygen, water, etc. in the surrounding gas (such as air) is directly or indirectly reacted thereto to form a reactive group such as a hydroxyl group on the surface of the bonding surface 23a and the surfaces of the bonding surfaces 31a. This state is similar to a state of the surface of the bonding surface 23a and the surfaces of the bonding surfaces 31a irradiated with the ultraviolet rays.

Then, the first electrode layer 2 is overlapped with the plurality of columnar parts 31 of the displacement layer 3 to integrally bond the bonding surface 23a of the first electrode layer 2 to the bonding surfaces 31a of the columnar parts 31. At this time, the first electrode layer 2 and the plurality of columnar parts 31 of the placement layer 3 may be preferably overlapped with each other immediately after application of the ultraviolet rays. The overlapping may be performed at room temperature or at heating temperature. Also, weight may be preferably applied in an overlapped direction after the bonding surface 23a of the first electrode layer 2 is overlapped with the bonding surfaces 31a of the columnar parts 31. In addition, after the overlapping, the first electrode layer 2 and the columnar parts 31 of the displacement layer 3 may be preferably left for a while in the overlapped state. This step corresponds to a step of overlapping the bonding layer with the columnar parts to integrally bond the bonding layer to the columnar parts after the easy adhesion treatment step.

On the other hand, the electrode 43 is formed on one of the surfaces of the base film 42 and the rubbery elastic layer 41 is formed on the other surface to form the second electrode layer 4. To form the rubbery elastic layer 41 on the base film 42, for example, silicone rubber containing a component showing adhesiveness with respect to the base film 42 may be applied through screen printing.

Then, ultraviolet rays similar to those mentioned above are applied to a bonding surface 41a of the second electrode layer 4 that is opposed to the columnar parts 31 of the displacement layer 3 and bonding surfaces 31b of the columnar parts 31 of the displacement layer 3 that are opposed to the second electrode layer 4. The easy adhesion treatment such as vacuum plasma treatment, atmospheric pressure plasma treatment, corona treatment, and flame treatment may be performed in place of application of the ultraviolet rays, as with the bonding surfaces 23a and 31a. This step corresponds to the easy adhesion treatment step of performing the easy adhesion treatment on one or both of a surface of the bonding layer to be bonded to the columnar parts and surfaces of the columnar parts to be bonded to the bonding layer.

Then, the second electrode layer 4 is overlapped with the plurality of columnar parts 31 of the displacement layer 3 to integrally bond the bonding surface 41a of the second electrode layer 4 to the bonding surfaces 31b of the columnar parts 31. At this time, the second electrode layer 4 and the plurality of columnar parts 31 of the placement layer 3 may be preferably overlapped with each other immediately after application of the ultraviolet rays. The overlapping may be performed at room temperature or at heating temperature. Also, weight may be preferably applied in an overlapped direction after the bonding surface 41a of the second electrode layer 4 is overlapped with the bonding surfaces 31b of the columnar parts 31. After the overlapping, the second electrode layer 4 and the columnar parts 31 of the displacement layer 3 may be preferably left for a while in the overlapped state. This step corresponds to the step of overlapping the bonding layer with the columnar parts to integrally bond the bonding layer to the columnar parts after the easy adhesion treatment step.

The detection sensor 1 illustrated in (1A) of FIG. 1 is completed through the above-described steps.

Next, a mechanism of bonding between the columnar parts 31 and the bonding layers (the rubbery conductor layers 23 and 41, or the coating layer containing a silane compound) in manufacturing the detection sensor 1 is described.

When ultraviolet rays including a wavelength of 172 nm is applied from an excimer lamp, the ultraviolet rays directly act on surrounding oxygen (O₂) to generate active oxygen (O(¹D)). Also, the ultraviolet rays change oxygen (O₂) into ozone (O₃), and change ozone (O₃) into oxygen (O₂) and active oxygen (O(¹D)).

In the initial state before bonding, CH₃ groups exist on the surfaces of the rubbery elastic layers 23 and 41 (or the silane coupling agent layers) and the surfaces of the columnar parts 31.

When the ultraviolet rays including a wavelength of 172 nm is applied to such surfaces of the rubbery elastic layers 23 and 41 (or the coating layers each containing a silane compound) and the surfaces of the columnar parts 31, the surfaces of the rubbery elastic layers and the surfaces of the columnar parts 31 are oxidized by the ultraviolet rays and active oxygen that is generated by application of the ultraviolet rays to surrounding oxygen. As a result, the CH₃ groups on the surfaces of the rubbery elastic layers 23 and 41 (or the coating layers each containing a silane compound) and the surfaces of the columnar parts 31 are oxidized to be OH groups.

Thereafter, the surfaces of the rubbery elastic layers 23 and 41 (or the coating layers each containing a silane compound) are overlapped with the surfaces of the columnar parts 31, weight is applied thereto in the overlapped direction, and the resultant is retained at room temperature for a predetermined time. As a result, the OH groups on the surfaces of the rubbery elastic layers 23 and 41 (or the coating layers each containing a silane compound) and the OH groups on the surfaces of the columnar parts 31 are bonded to each other to generate water, and silicon (Si) of the rubbery elastic layer 23 and 41 (or the coating layers each containing a silane compound) and silicon (Si) of the columnar parts 31 are bonded to each other through oxygen (O). Such a bonding state without an interposition such as an adhesive is referred to as integral bonding.

The rubbery elastic layers 23 and 41 (or the coating layers each containing a silane compound) are integrally bonded to the columnar parts 31 as mentioned above, which makes it possible to appropriately prevent easy detachment therebetween, and to improve reliability. In this way, it is possible to integrally bond the rubbery elastic layers 23 and 41 (or the coating layers each containing a silane compound) to the columnar parts 31 without using an adhesive and a bonding agent. This makes it possible to prevent the rubbery elastic layers 23 and 41 (or the coating layers each containing a silane compound) and the columnar parts 31 from being displaced, warping, or being raised when pressed, and accordingly to improve reliability of the detection sensor 1. Further, since an adhesive and a bonding agent are not used, dripping does not occur in the clearance around the columnar parts 31, which prevents variation in pressing feeling. Also, an adhesive and a bonding agent are not used, which prevents application unevenness of an adhesive, and the like, and accordingly prevents variation in pressing feeling. In addition, since an adhesive and a bonding agent are not used, a width of the detection sensor 1 in the pressing direction is made thin. Further, the columnar parts 31 are integrally bonded to the rubbery elastic layers 23 and 41 without interposition of an adhesive, which makes it possible to maintain high reliability of adhesion. As a result, it is possible to maintain high dimension accuracy between the upper electrode and the lower electrode.

### Second Embodiment

Next, a detection sensor according to a second embodiment of the present invention is described. In the present embodiment, components common to those in the first embodiment are assigned with the same reference numerals, and the description thereof are appropriately omitted.

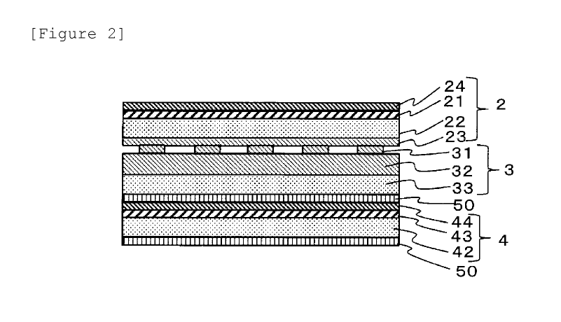

FIG. 2 is a sectional diagram of the detection sensor according to the second embodiment of the present invention.

In the detection sensor 1 according to the second embodiment, the plurality of columnar parts 31 are provided on a base film 33 in the displacement layer 3 to make handling of the plurality of columnar parts easy.

The detection sensor 1 includes the first electrode layer 2, the displacement layer 3, an adhesive layer 50, the second electrode layer 4, and an adhesive layer 50 in order from the operation surface side.

The first electrode layer 2 includes a resist layer 24, the electrode 21, the base film 22, and the rubbery elastic layer 23 in order from the operation surface side (upper side in the figure). The resist layer 24 is a layer protecting the electrode 21. The resist layer 24 is a layer having a thickness of, for example, 20 μm. The base film 22 is a film having a thickness of, for example, 50 μm.

The displacement layer 3 includes a base film 33, a rubbery elastic layer 32, and the columnar parts 31 in order away from the operation surface. The rubbery elastic layer 32 is an example of a plate layer, and is formed of a rubbery elastic body similar to that of the columnar parts 31. The columnar parts 31 and a bottom surface of the rubbery elastic layer 23 are integrally formed.

The adhesive layer 50 below the displacement layer 3 is a layer bonding the displacement layer 3 to the second electrode layer 4. The adhesive layer 50 is, for example, a double-sided tape. As a material of the adhesive layer 50, for example, 467 commercially available from 3M that is an acrylic adhesive tape may be used.

The second electrode 4 includes the base film 42, the electrode 43, and a resist layer 44 in order away from the operation surface. The resist layer 44 is a layer protecting the electrode 43. The resist layer 44 is a layer having a thickness of, for example, 20 μm.

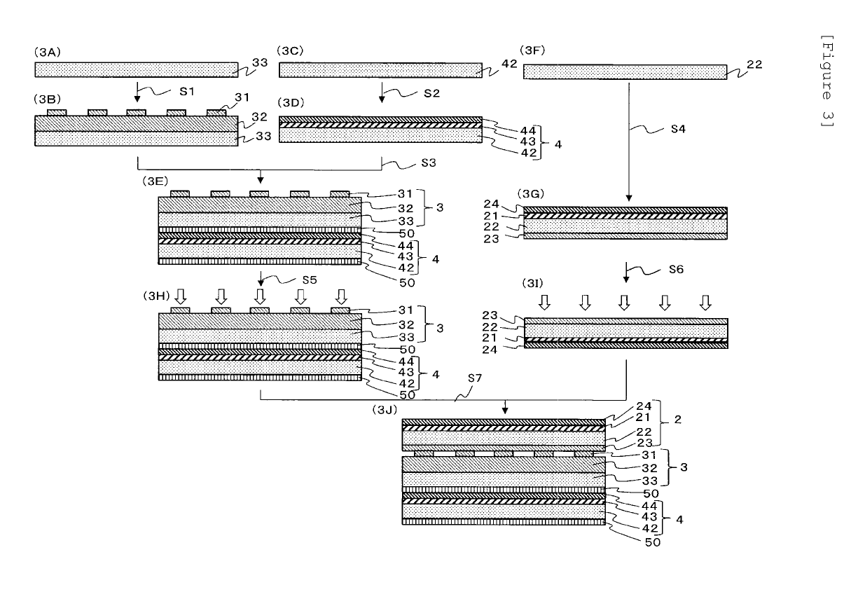

FIG. 3 is a diagram for explaining a method of fabricating the detection sensor according to the second embodiment of the present invention.

First, as illustrated in (3A), a polyethylene terephthalate film is prepared as the base film 33. Then, a silicone-based primer is applied on a top surface of the base film 33, and is left at room temperature for one hour. The base film 33 is put in a mold having a recess defining the shapes of the rubbery elastic layer 32 and the plurality of columnar parts 31, the mold is filled with silicone rubber as a raw material, and press molding is performed under the condition, for example, at molding temperature of 135° C. for a molding time of four minutes, followed by drying for example, at drying temperature of 150° C. for a drying time of 30 minutes (step S1). At this time, in the recess of the mold, a plurality of recesses for columnar parts that each have a flat bottom surface and each define the shape of each of the plurality of columnar parts 31 are uniformly provided in matrix. As a result, as illustrated in (3B), the displacement layer 3 in which the primer applied surface of the base film 33 and both the rubbery elastic layer 32 and the plurality of columnar parts 31 are integrated is formed. In the formed displacement layer 3, the top surface of each columnar part 31 is flat, and the shape of the mold is transferred thereto with high accuracy. The shape of each columnar part 31 is a circular-column shape having, for example, a height of 0.1 mm and a diameter of 1 mm. The columnar parts 31 are uniformly disposed on the rubbery elastic layer 32 with a density of about 50% in planar view.

On the other hand, as illustrated in (3C), the base film 42 is prepared, the electrode layer 43 is formed on one of the surfaces of the base film 42, and the resist layer 44 is formed on the electrode layer 43 to form the second electrode layer 4 (step S2).

Thereafter, the adhesive layer 50 to bond the second electrode layer 4 to the other component is attached to the bottom surface (a bottom surface of the base film 42) of the second electrode layer 4, and the bottom surface (a bottom surface of the base film 33) of the displacement layer 3 illustrated in (3B) and the top surface (a top surface of the resist layer 44) of the second electrode layer 4 illustrated in (3D) are bonded to each other with the adhesive layer 50 in between. An unnecessary outer part of the obtained bonded structure is cut by a blade tool and removed (step S3). As a result, as illustrated in (3E), the structure in which the displacement layer 3 and the second electrode layer 4 is bonded to each other is formed.

Further, as illustrated in (3F), the base film 22 is prepared. Then, the electrode layer 21 is formed on one of the surfaces of the base film 22, and the resist layer 24 is formed on the electrode layer 21. Subsequently, silicone rubber that contains a component showing high adhesiveness with respect to the base film 22 is applied, with a thickness of, for example, 20 μm, on the other surface of the base film 22 through screen printing. The base film 22 applied with the silicone rubber is left, for example, at temperature of 80° C. for one hour to form the rubbery elastic layer 23, thereby forming the first electrode layer 2 as illustrated in (3G) (step S4).

Then, as illustrated in (3H), ultraviolet rays including a wavelength of 172 nm are applied from a side close to the columnar parts 31 in the structure illustrated in (3E), for 90 seconds, with illuminance at which the ultraviolet rays of the wavelength of 172 nm become, for example, 4 mW/cm2 (step S5). In addition, as illustrated in (3I), ultraviolet rays including a wavelength of 172 nm are also applied from a side close to the rubbery elastic layer 23 in the structure illustrated in (3G), for 90 seconds, with illuminance at which the ultraviolet rays of the wavelength of 172 nm become, for example, 4 mW/cm² (step S6). This step corresponds to the easy adhesion treatment step of performing easy adhesion treatment on one or both of a surface of the bonding layer to be bonded to the columnar parts and surfaces of the columnar parts to be bonded to the bonding layer.

Then, the structure illustrated in (3H) and the structure illustrated in (3I) are both absorbed and fixed on a bonding tool to bond, with high accuracy, the columnar part 31 irradiated with the ultraviolet rays to the surface of the rubbery elastic layer 23 irradiated with the ultraviolet rays. The bonded structure is compressed by an amount corresponding to 1% or more and 40% or less, and more preferably 5% or more and 20% or less of the height of the columnar parts 31 in the pressing direction, and is retained for five minutes (step S7). This step corresponds to a step of overlapping the bonding layer and the columnar parts to integrally bond the bonding layer to the columnar parts after the easy adhesion treatment step. As a result, as illustrated in (3J), the detection sensor 1 in which the columnar parts 31 and the rubbery elastic layer 23 are integrally bonded to each other is formed.

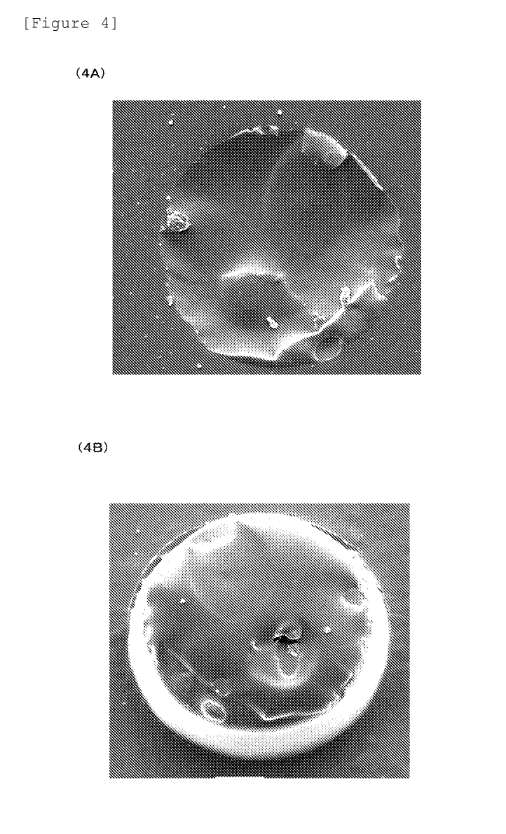

FIG. 4 is an electron microscope photograph of the surface of the columnar part and the surface of the rubbery elastic layer of the detection sensor according to the second embodiment of the present invention after peeling the columnar part and the rubbery elastic layer of the detection sensor. (4A) is an electron microscope photograph of the surface of the rubbery elastic layer 23 after peeling, and (4B) is an electron microscope photograph of the surface of one of the columnar parts 31 after peeling.

After an end of the first electrode layer 2 and an end of the second electrode layer 4 of the detection sensor 1 fabricated in the above described manner was gripped by respective jigs, a 90 degree peel test was performed. In observation of the surfaces of the columnar parts 31 and the surface of the rubbery elastic layer 23 after peeling by an electron microscope, as illustrated in (4A) and (4B), cohesion failure occurred at a part of the rubbery elastic layer 23, and the part was attached to the most region of the top surface of the columnar part 31. The same was observed in all of the columnar parts 31 of the detection sensor 1.

On this occasion, in a case where the first electrode layer and the columnar parts are not fixed, when a predetermined part of the detection sensor is pressed and operated, a part near the pressed and operated part of the first electrode layer is floated, and the floating accordingly causes variation in electrostatic capacitance of the detection sensor. The reason why such floating occurs is because the first electrode layer is formed of a resin, glass, or the like and has fixed elastic modulus. According to the detection sensor 1 fabricated in the present embodiment, the first electrode layer and the columnar parts are appropriately fixed to each other, which makes it possible to appropriately prevent such a state from occurring.

In the second embodiment, the displacement layer 3 further includes the base film 33 and the rubbery elastic layer 32 in addition to the columnar parts 31. As for the base film 33, in manufacturing the detection sensor 1, it is not so difficult to form the plurality of columnar parts 31 on the base film 33 and to perform alignment with high accuracy in bonding to other components. Further, handling of the displacement layer 3 is also easy. The base film 33 does not prevent deformation of the first electrode layer provided below the columnar parts 31. Since the rubbery elastic layer 32 and the columnar parts 31 are formed as an integral component as understood from the above-described fabrication method, bonding of the fine columnar parts 31 to the base film 33 is performed easily.

<Modifications>

Next, modifications of the detection sensor according to the second embodiment of the present invention are described. In the modifications, components common to those in the second embodiment are assigned with the same reference numerals, and the description thereof are appropriately omitted.

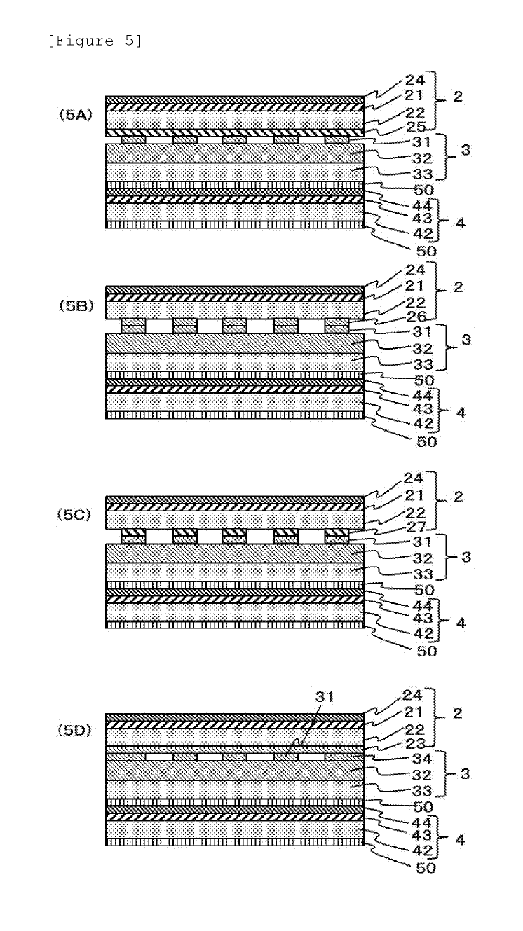

FIG. 5 is a sectional diagram of the detection sensors according to the respective modifications of the present invention. (5A) to (5D) illustrate the detection sensors according to the respective modifications.

First, the detection sensor 1 according to a first modification is described.

The detection sensor 1 according to the first modification illustrated in (5A) includes a silane coupling agent layer 25 in place of the rubbery elastic layer 23 in the detection sensor 1 according to the second embodiment illustrated in FIG. 2.

A kind of a silane coupling agent of the silane coupling agent layer 25 may be optional as long as the silane coupling agent is suitable for the base film 22. The silane coupling agent layer 25 may be formed of a primer obtained by diluting, with a solvent, KBE-903 commercially available from Shin-Etsu Chemical Co., Ltd. or one to two kinds of silane coupling agents, or may be formed of an aminosilane-based primer (for example, KPB-40 commercially available from Shin-Etsu Chemical Co., Ltd.).

In the detection sensor 1, the silane coupling agent layer 25 is integrally bonded to the columnar parts 31. Therefore, the detection sensor 1 according to the first modification has effects similar to those of the detection sensor according to the second embodiment. Further, according to the first modification, the rubbery elastic layer 23 is replaced with the silane coupling agent layer 25, which results in improvement in pressing feeling to the detection sensor 1. Further, it is possible to reduce the thickness of the detection sensor 1 in the Z direction.

Next, the detection sensor 1 according to a second modification is described.

The detection sensor 1 according to the second modification illustrated in (5B) includes a rubbery elastic layer 26 in place of the rubbery elastic layer 23 in the detection sensor 1 according to the second embodiment.

The rubbery elastic layer 26 is formed of a rubbery elastic body similar to that of the rubbery elastic layer 23; however, the rubbery elastic layer 26 is different in region where the rubbery elastic body is provided from the rubbery elastic layer 23. The rubbery elastic layer 26 is provided in a region that is a part of the base film 22 and includes parts corresponding to the bonding surfaces of the columnar parts 31 to be bonded. For example, the rubbery elastic layer 26 may include the rubbery elastic body in a linear region including the parts corresponding to the bonding surfaces of the plurality of columnar parts 31 that are arranged in a depth direction of the figure. In the detection sensor 1, the rubbery elastic layer 26 is integrally bonded to the columnar parts 31.

According to the second modification, the rubbery elastic layer 26 is provided in a partial region of the base film 22, which makes it possible to reduce a region occupied by the rubbery elastic body in the surface of the base film 22. It is accordingly possible to further improve the pressing feeling to the detection sensor 1.

Next, the detection sensor 1 according to a third modification is described.

The detection sensor 1 according to the third modification illustrated in (5C) includes a silane coupling agent layer 27 in place of the rubbery elastic layer 26 in the detection sensor 1 according to the second modification.

A silane coupling agent forming the silane coupling agent layer 27 is similar to that of the silane coupling agent layer 25. In the detection sensor 1, the silane coupling agent layer 27 is integrally bonded to the columnar parts 31.

According to the third modification, the rubbery elastic layer 26 is replaced with the silane coupling agent layer 27. Therefore, as compared with the second modification, it is possible to improve the pressing feeling to the detection sensor 1 and to reduce the thickness of the detection sensor 1 in the Z direction.

Next, the detection sensor 1 according to a fourth modification is described.

The detection sensor 1 according to the fourth modification illustrated in (5D) further includes a wall part 34 in the displacement layer 3 of the detection sensor 1 according to the second embodiment.

The wall part 34 is formed of a rubbery elastic body similar to the rubbery elastic body of the columnar parts 31, and is provided at the periphery of the displacement layer 3. The wall part 34 has the same height as the columnar parts 31, and is integrally bonded to the rubbery elastic layer 23 similarly to the columnar parts 31. Accordingly, it is possible to improve bonding strength between the first electrode layer 2 and the displacement layer 3. Further, the wall part 34 allows to shield the clearance around the columnar parts 31 from outside, and to prevent foreign matter from entering the clearance around the columnar parts 31, thereby improving the reliability of the detection sensor 1. Note that fine air holes may be provided on the wall part 34 to allow movement of air during thermal expansion and pressing while preventing foreign matter from entering.

### Third Embodiment

Next, a detection sensor according to a third embodiment of the present invention is described. In the present embodiment, components common to those in any of the above-described embodiments are assigned with the same reference numerals, and the description thereof are appropriately omitted.

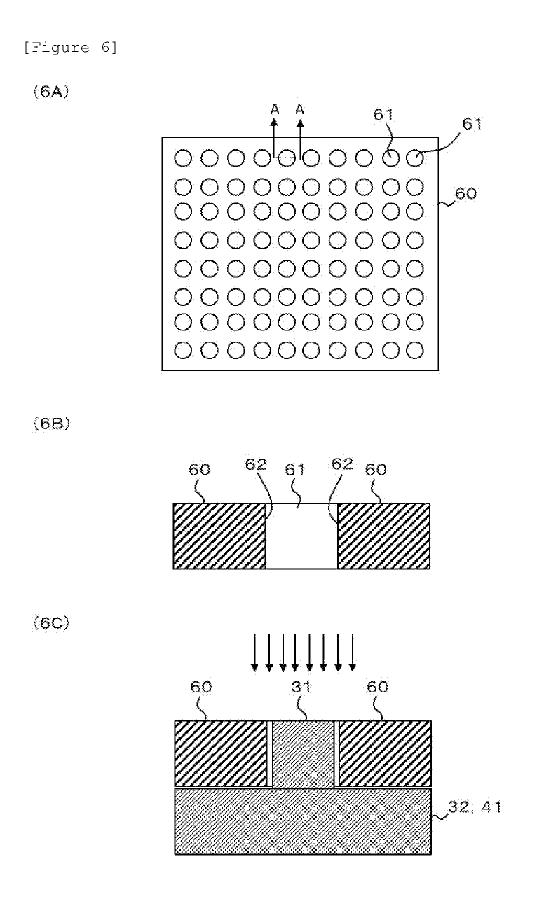

FIG. 6 is a plan view (6A) of a masking jig used in fabricating the detection sensor according to the third embodiment of the present invention, an A-A enlarged sectional diagram (6B) illustrating a region near one of a plurality of through holes provided in the masking jig, and an enlarged sectional diagram (6C) illustrating a state in which the columnar parts are inserted into the respective through holes of the masking jig and the easy adhesion treatment is performed on top surfaces thereof in the same field of view as (6B).

A masking jig 60 illustrated in (6A) of FIG. 6 is a jig used for performing the easy adhesion treatment (in the present embodiment, application of ultraviolet rays with use of an excimer lamp is described as a representative example) on the top surfaces of the columnar parts 31 of the displacement layer 3. The masking jig 60 includes a plurality of through holes 61 into which the respective columnar parts 31 are insertable. The masking jig 60 in the present embodiment includes the through holes 61 regularly arranged in vertical and lateral directions; however, the number and the arrangement of the through holes 61 are not limited to those exemplified in (6A) of FIG. 6. The masking jig 60 is suitably formed of a metal represented by SUS or a resin. The through holes 61 are easily formable through cutting, etching, or any other method. Each of the through holes 61 of the masking jig 60 is designed to have a diameter slightly larger than the diameter of each columnar part 31. This is because such design makes it easy to perform alignment between the plurality of columnar parts 31 on the rubbery elastic layer 32 or 41 and the same number of through holes 61.

Each through hole 61 of the masking jig 60 illustrated in (6B) of FIG. 6 is a cylindrical hole that penetrates the masking jig 60 in a front and rear direction while maintaining the fixed diameter. An inner wall 62 of each through hole 61 is substantially perpendicular. The columnar parts 31 configuring the detection sensor 1 according to the present embodiment each have a circular-column shape. The detection sensor 1 according to the present embodiment is fabricated through the steps illustrated in FIG. 3, as with the detection sensor 1 according to the second embodiment. In the fabrication steps, the masking jig 60 is put over the columnar parts 31 to insert the columnar parts 31 into the respective through holes 61 at the time of application of the ultraviolet rays in step S5. The detection sensor 1 according to the present embodiment is different from the detection sensor 1 according to the second embodiment in that the detection sensor 1 according to the present embodiment is fabricated through the above-described masking treatment and then the easy adhesion treatment.

There is a slight gap between a side surface of each columnar part 31 inserted into the through hole 61 of the masking jig 60 and the inner wall 62 of the through hole 61. In addition, the thickness of the masking jig 60 is equal to or slightly larger than the height of the columnar parts 31. Therefore, the columnar parts 31 are placed in a state where mainly the top surfaces thereof are exposed from the through holes 61 with the small gap between each of the side surfaces of the columnar parts 31 and the inner wall 62 of the corresponding through hole 61. As illustrated in (6C) of FIG. 6, when ultraviolet rays are applied to the top surfaces of the columnar parts 31 (in an arrow direction in 6C) in this state, the ultraviolet rays are intensively or preferentially applied to the top surfaces of the columnar parts 31. Almost all region of the side surfaces of the columnar parts 31 is not irradiated with the ultraviolet rays even though the small region thereof may be possibly irradiated with the ultraviolet rays. Further, the surroundings of the columnar parts 31 is hardly irradiated with the ultraviolet rays. Masking the side surfaces of the columnar parts 31 and the surroundings of the columnar parts 31 in the above-described manner makes mostly the top surfaces of the columnar parts 31 into a bondable active region, and makes the most region of the side surfaces and the surroundings of the columnar parts 31 into an unbondable inactive region. As a result, even when the compression force is applied to the columnar parts 31 in the height direction in step S7 in FIG. 3, it is possible to suppress disadvantageous bonding of the rubbery elastic layer 23 on the base film 22 side to a region other than the top surfaces of the columnar parts 31. This makes it possible to effectively prevent size reduction of the columnar parts 31 (also referred to as reduction in clearance) caused by bonding of the region other than the top surfaces of the columnar parts 31 to the rubbery elastic layer 23 serving as the bonding layer. It is conceivable that the compression force in bonding is reduced in order to prevent the rubbery elastic layer 23 on the base film 22 side from being bonded to the region other than the top surfaces of the columnar parts 31. However, reduction of the compression force is not preferable because another issue of low bonding strength between the columnar parts 31 and the rubbery elastic layer 23 occurs. By performing the masking treatment, the easy adhesion treatment is prevented from being applied to the side surfaces and the surroundings of the columnar parts 31 while being performed on the top surfaces of the columnar parts 31. This makes it possible to perform the bonding step with sufficiently large compression force. As a result, it is possible to enhance the bonding strength between the columnar parts 31 and the rubbery elastic layer 23 and to ensure designed clearance.

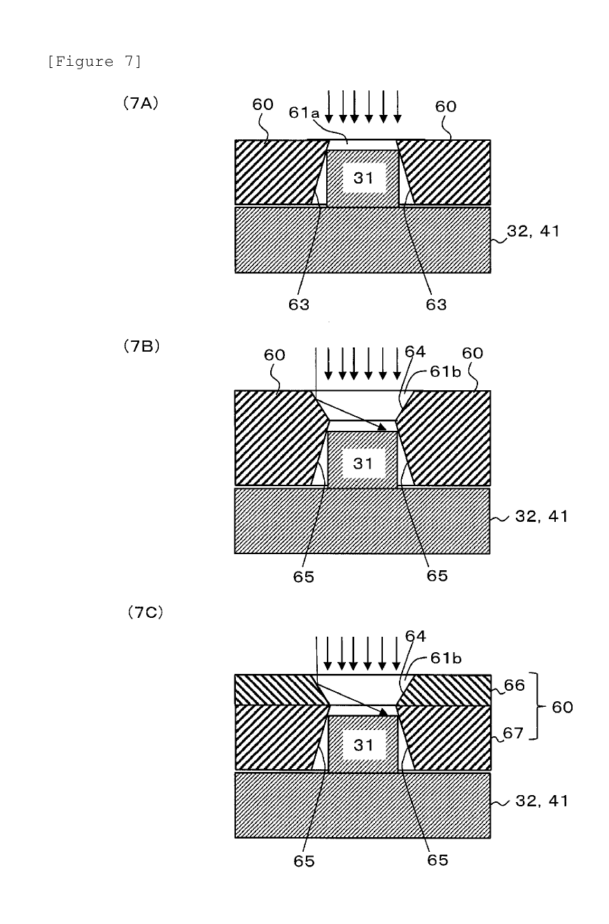

FIG. 7 illustrates some modifications of the masking jig of FIG. 6.

(7A) of FIG. 7 is an enlarged sectional diagram illustrating a state where the masking jig 60 that includes tapered through holes 61a each expanded in diameter toward the rubbery elastic layer 32 or 41 is put over the columnar parts 31. An arrow in FIG. 7 indicates application of ultraviolet rays. The same applies to subsequent drawings. A diameter of an upper part of each through hole 61a is smaller than the diameter of each columnar part 31. Thus, when the masking jig 60 is put over the columnar parts 31, the columnar parts 31 are in contact with the respective tapered inner walls 63 of the through holes 61a while the top surfaces of the columnar parts 31 are viewable from above the through holes 61.

When such tapered through holes 61a are formed, it is possible to make insertion of the columnar parts 31 into the respective through holes 61a easy, to prevent the easy adhesion treatment from being applied to the side surfaces of the columnar parts 31 substantially completely, and to easily perform the easy adhesion treatment only on the top surfaces of the columnar parts 31. However, when an angle of the inner wall 63 of each through hole 61a is excessively larger than the perpendicular direction, the degree of exposure of the top surfaces of the columnar parts 31 as viewed from directly above is lowered and the area of the top surfaces to be subjected to the easy adhesion treatment is decreased. Therefore, each inner wall 63 may be preferably a substantially perpendicular tapered surface.

(7B) of FIG. 7 is an enlarged sectional diagram illustrating a state where the masking jig 60 including hourglass-shaped through holes 61b is put over the columnar parts 31. Each of the hourglass-shaped through holes 61b is expanded in diameter toward the rubbery elastic layer 32 or 41 and is also expanded in diameter toward the opposite side. The top surface of each columnar part 31 is in contact with the inner wall 65 of a lower part of each through hole 61b at a middle position. Performing the easy adhesion treatment with use of the masking jig 60 including the through holes 61b with such shapes makes it possible to easily insert the columnar parts 31 into the respective through holes 61b, to prevent the easy adhesion treatment from being applied to the side surfaces of the columnar parts 31 substantially completely, and to easily perform the easy adhesion treatment on large regions of the top surfaces of the columnar parts 31. Since the inner wall 65 of each through hole 61b on side close to the rubbery elastic layer 32 or 41 is expanded in diameter in a tapered shape. This makes it easy to insert the columnar parts 31 thereinto. In addition, an inner wall 64 of each through hole 61b on a side opposite to the rubbery elastic layer 32 is also expanded in diameter in a tapered shape. Thus, it is possible to ensure wide entering area of ultraviolet rays, and accordingly to easily apply the ultraviolet rays on the wide regions of the top surfaces of the columnar parts 31 with use of reflection of the ultraviolet rays by the respective inner walls 64. Note that each inner wall 64 may be preferably subjected to mirror surface treatment in order to enhance reflection efficiency of the ultraviolet rays.

(7C) of FIG. 7 is an enlarged sectional diagram illustrating a state where the masking jig 60 that includes the through holes 61b with the same shape as those in (7B) of FIG. 7 and is configured of two layers, is put over the columnar parts 31. A first layer 66 configuring the masking jig 60 includes the inner walls 64, and a second layer 67 includes the inner walls 65. The second layer 67 may be preferably formed of a material having hardness lower than that of the columnar parts 31. When the second layer 67 is formed of such a material, excessive pressure is not applied to the columnar parts 31 even if the peripheral part of the top surface of each columnar part 31 is in contact with the inner wall 65. Accordingly, deformation of the columnar parts 31 is effectively prevented even if the thickness of the second layer 67 and the tapered angle are not strictly regulated. Note that a material of the first layer 66 may have hardness higher than, lower than, or equivalent to the hardness of the material of the columnar parts 31.

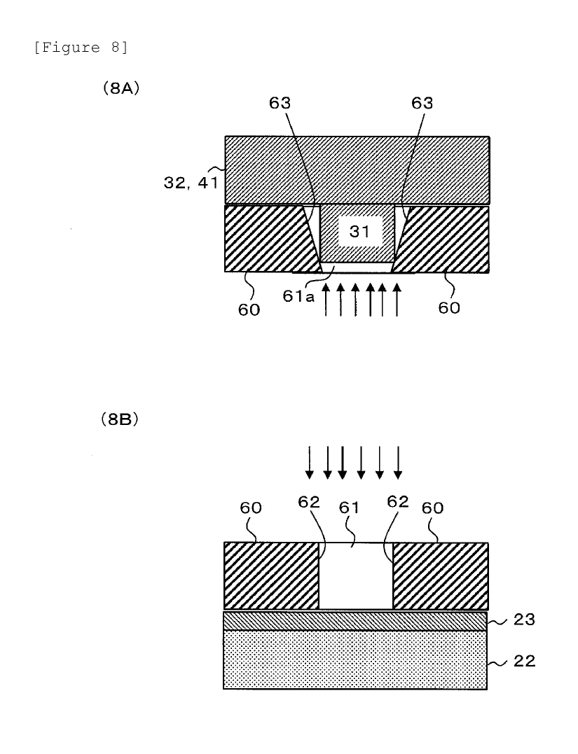

FIG. 8 is an enlarged sectional diagram (8A) illustrating a state in which the masking jig of (7A) of FIG. 7 is upside down and each columnar part is inserted into the through hole of the masking jig from side of an expanded-diameter part, and an enlarged sectional diagram (8B) illustrating another usage example of the masking jig.

As illustrated in (8A) of FIG. 8, the top surfaces of the columnar parts 31 may be turned downward, and the columnar parts 31 may be inserted into the respective through holes 61a of the masking jig 60 from the expanded-diameter parts thereof, and then the easy adhesion treatment may be performed toward the top surfaces of the columnar parts 31 from side opposite to the expanded-diameter parts. The masking jig 60 having a shape illustrated in any of (6B) of FIG. 6 and (7B) and (7C) of FIG. 7 may be used upside down similarly. In this way, inserting the columnar parts 31 into the masking jig 60 placed therebelow from above and then performing the easy adhesion treatment is effective particularly to prevent deformation of the columnar parts 31 caused by the weight of the masking jig 60 derived when the columnar parts 31 are in contact with the respective inner walls 63 or 65 of the through holes 61a or 61b.

In addition, as illustrated in (8B) of FIG. 8, the masking jig 60 is used in a case where the easy adhesion treatment is performed only on a local region to be bonded to the columnar parts 31, in a bonding layer on a side to be bonded to the top surfaces of the columnar parts 31, namely, in the rubbery elastic layer 23 on the base film 22. Here, the masking jig 60 having the through holes 61 has been described as an example; however, the masking jig 60 having through holes 61a and 61b with other shapes may be used to perform the easy adhesion treatment on the rubbery elastic layer 23.

### Fourth Embodiment

Next, a detection sensor according to a fourth embodiment of the present invention is described. In the present embodiment, components common to those in any of the above-described embodiments are assigned with the same reference numerals, and the description thereof are appropriately omitted.

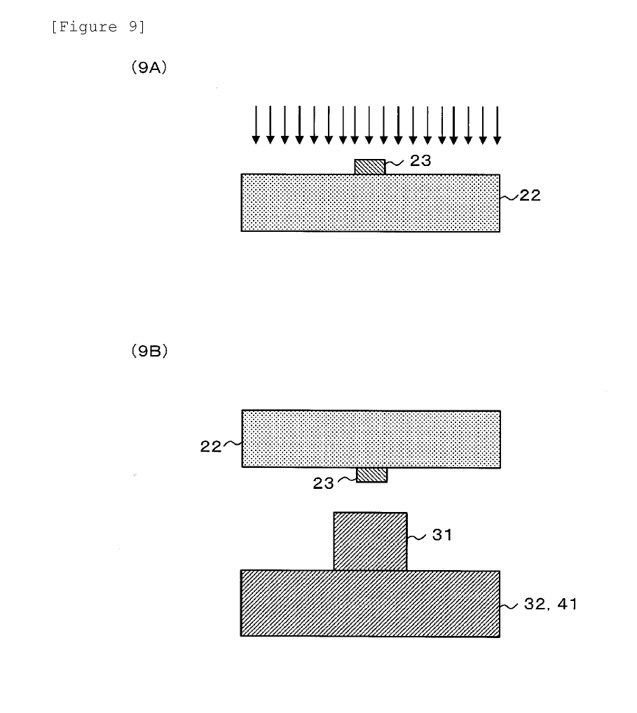

FIG. 9 is a diagram for explaining a method of fabricating a detection sensor in which the top surface of the rubbery elastic layer serving as the bonding layer to be bonded to the columnar parts is smaller in area than the top surface of each columnar part.

The feature of the detection sensor 1 according to the present embodiment is that the rubbery elastic layer 23 serving as the bonding layer having a top surface smaller in area than the top surface of each columnar part 31 is bonded to the top surface of each columnar part 31. As illustrated in (9A) of FIG. 9, when the top surface of the rubbery elastic layer 23 is smaller in area than the top surface of each columnar part 31, the easy adhesion treatment may be performed on the top surface and the side surface of the rubbery elastic layer 23 and the base film 22 without using the masking jig 60 that is used in the third embodiment.

In such a case, as illustrated in (9B) of FIG. 9, when the top surface of each columnar part 31 is bonded to the top surface of the rubbery elastic layer 23, the base film 22 may come into contact with the top surfaces of the columnar parts 31. The base film 22, however, does not form an easy adhesion surface by application of ultraviolet rays or the like, and therefore the base film 22 is not bonded to the columnar parts 31. Accordingly, issues such as deformation of the columnar parts 31, reduction in clearance, and deficiency in bonding strength that may occur in order to prevent the deformation of the columnar parts 31 and reduction in clearance, do not occur.

<Feature of Each Bonding Method>

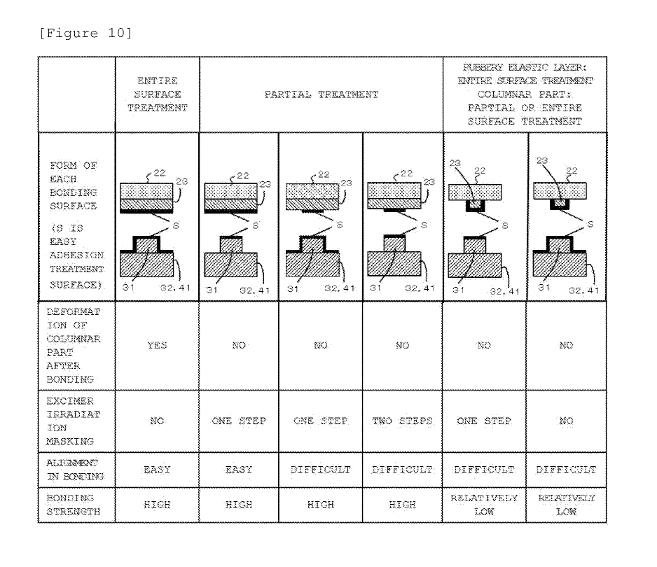

FIG. 10 illustrates comparison of superiority between cases where the columnar parts are bonded to the bonding layer through the above-described various kinds of bonding methods. In the figure, a black line S indicates the easy adhesion treatment surface.

In the third embodiment and the fourth embodiment mentioned above, the easy adhesion treatment is performed intensively on the bonding surfaces of the columnar parts 31 to be bonded to the bonding layer (for example, the rubbery elastic layer 23) and/or the bonding surface of the bonding layer to be bonded to the columnar parts 31, to integrally bond the columnar parts 31 to the bonding layer. “Intensively” used herein is not intended to mean 100%. Therefore, performing the easy adhesion treatment intensively on the bonding surfaces of the columnar parts 31 to be bonded to the bonding layer and/or the bonding surface of the bonding layer to be bonded to the columnar parts 31 is not necessarily intended to mean performing the easy adhesion treatment only on the mentioned bonding surfaces, and is intended to mean performing the easy adhesion treatment by eliminating a region other than the bonding surfaces as much as possible. Therefore, even if the easy adhesion treatment is performed on a small region (for example, a part of the side surface near the top surface of the columnar part 31) other than the bonding surfaces (for example, the top surfaces of the columnar parts 31), the easy adhesion treatment is regarded as being performed intensively on the bonding surfaces in a case where the area of the small region is remarkably smaller than the area of the bonding surfaces.

When the easy adhesion treatment is performed on both the entire bonding surface of the rubbery elastic layer 23 as the bonding layer and the entire bonding surfaces of the columnar parts 31, it is unnecessary to use the masking jig 60, and it is excellent in easiness of bonding and bonding strength. On the other hand, the possibility that the columnar parts 31 deform after bonding is higher than a method described below.

When the easy adhesion treatment is partially performed on one or both of the rubbery elastic layer 23 and the columnar parts 31, it is necessary to use the masking jig 60 at least once. In addition, when the partial easy adhesion treatment is performed on the rubbery elastic layer 23, it is difficult to perform alignment of bonding. In contrast, the partial easy adhesion treatment mentioned above provides high bonding strength and does not cause deformation of the columnar parts 31.

When the surface of the rubbery elastic layer 23 is smaller in area than the surface of each columnar part 31, an issue of deformation of the columnar parts 31 does not occur even though the alignment and bonding strength in bonding are slightly inferior to the above-described method. In addition, it is possible to perform the easy adhesion treatment on the entire bonding surfaces of the columnar parts 31, and in this case, the masking step is unnecessary.

### Other Embodiments

Hereinbefore, although some embodiments of the present invention have been described, the present invention is not limited to the above-described embodiments, and is applicable to other various modes.

For example, in the above-described first to fourth embodiments, each columnar part 31 has a dot shape as an example. However, the shape of each columnar part 31 is not limited thereto, and for example, is a line shape.

In the second embodiment and its modification described above, the first electrode layer 2 is integrally bonded to the columnar parts 31 of the displacement layer 3. However, the present invention is not limited thereto. The second electrode layer 4 may be integrally bonded to the columnar parts 31 of the displacement layer 3. In other words, the columnar parts 31 may be integrally bonded to one or both of the first electrode layer 2 and the second electrode layer 4.

In the above-described first and second embodiments, the electrode of the first electrode layer 2 on the operation surface side serves as a drive electrode, and the electrode of the second electrode layer 4 on the side away from the operation surface serves as a receiving electrode. Alternatively, the electrode of the first electrode layer 2 may serve as a receiving electrode, and the electrode of the second electrode layer 4 may serve as a drive electrode.

In the above-described first and second embodiments, the detection sensor detecting the operation in the Z direction has been described as an example. Alternatively, a third electrode layer including an XY direction receiving electrode that detects a position in a flat surface of the operation surface (a position in the XY direction) may be further provided to detect operation in three-axis direction. In this case, the third electrode layer may be provided at, in the Z direction, any of a position closer to the operation surface than the first electrode layer 2, a position between the first electrode layer 2 and the displacement layer 3, a position between the displacement layer 3 and the second electrode layer, and a position far from the operation surface than the second electrode layer.

In addition, the XY direction receiving electrode may be provided in the first electrode layer or the second electrode layer. For example, the XY direction receiving electrode may be disposed on a surface opposite to the surface provided with the electrode of the base film of the first electrode layer or the second electrode layer, on the electrode with a resist in between, or the same surface of the electrode on the base film with a distance in between. When the XY direction receiving electrode is disposed on the first electrode layer located above the columnar parts, it is necessary for the first electrode layer including the XY direction receiving electrode to deform when the operation surface is pressed. Therefore, the thickness of the first electrode layer may be preferably 0.01 mm or more and 1 mm or less, and more preferably 0.01 mm or more and 0.4 mm or less.

In the above-described first and second embodiments, the columnar parts 31 of the displacement layer 3 is integrally bonded to one or both of one surface of the first electrode layer 2 and one surface of the second electrode layer 4. However, the present invention is not limited thereto. Alternatively, the columnar parts 31 of the displacement layer 3 may be integrally bonded to one or both of a surface on the first electrode layer 2 side facing the displacement layer 3 that is different from the first electrode layer 2 and a surface on the second electrode layer 4 side facing the displacement layer 3 that is different from the second electrode layer 4.

In the above-described first to fourth embodiments (including the modifications), the components of the respective embodiments may be optionally combined except a specific case where mutual combination is impossible.

### INDUSTRIAL APPLICABILITY

The present invention is used as a detection sensor detecting operation in a pressing direction or a touch pad capable of detecting operation in the pressing direction.

### REFERENCE SIGNS LIST

1 Detection sensor
2 First electrode layer
3 Displacement layer
4 Second electrode layer
23, 26, 41 Rubbery elastic layer (bonding layer)
25, 27 Silane coupling agent layer
31 Columnar part
32 Rubbery elastic layer (plate layer)
34 Wall part
60 Masking jig

1. A detection sensor configured to detect a pressing state on an operation surface in a pressing direction, the detection sensor comprising:
a first electrode layer and a second electrode layer both configured to detect variation in electrostatic capacitance; and
a displacement layer provided between the first electrode layer and the second electrode layer, the displacement layer being adapted to vary a distance between the first electrode layer and the second electrode layer in response to pressing of the operation surface, wherein
the displacement layer includes a rubbery elastic body and includes a plurality of columnar parts each stretchable in the pressing direction,
one or both of a surface of the first electrode layer facing the displacement layer and a surface of the second electrode layer facing the displacement layer are provided with a bonding layer that is configured of a rubbery elastic layer or a coating layer containing a silane compound, and
the columnar parts are integrally bonded to the bonding layer.

2. The detection sensor of claim 1, wherein easy adhesion treatment is intensively performed on bonding surfaces of the columnar parts to be bonded to the bonding layer and/or a bonding surface of the bonding layer to be bonded to the columnar parts to integrally bond the columnar parts to the bonding layer.

3. The detection sensor of claim 1, wherein the columnar parts and the bonding layer are overlapped to be integrally bonded to each other after application of ultraviolet rays, plasma treatment, or corona treatment is performed on the respective bonding surfaces.

4. The detection sensor of claim 1, wherein the columnar parts each have a circular-column shape or a truncated cone shape.

5. The detection sensor of claim 1, wherein the displacement layer includes a plate layer formed of a rubbery elastic body, and the columnar parts are formed integrally with the plate layer.

6. The detection sensor of claim 1, wherein the bonding layer is provided only in a partial region including a region corresponding to the bonding surfaces of the plurality of columnar parts, on one or both of the surface of the first electrode layer facing the displacement layer and the surface of the second electrode layer facing the displacement layer.

7. The detection sensor of claim 1, wherein the displacement layer includes, in a peripheral part, a wall part to shield inflow of air into the displacement layer from surroundings.

8. The detection sensor of claim 1, wherein
the first electrode layer includes a drive electrode to which a voltage is applied, to detect variation in electrostatic capacitance, and
the second electrode layer includes a receiving electrode generating a current corresponding to the distance between the first electrode layer and the second electrode layer.

9. The detection sensor of claim 1, wherein the rubbery elastic body is silicone rubber.

10. A detection sensor fabrication method, the detection sensor being configured to detect pressing operation of an operation surface in a pressing direction, the detection sensor including
a first electrode layer and a second electrode layer both configured to detect variation in electrostatic capacitance, and
a displacement layer provided between the first electrode layer and the second electrode layer, the displacement layer being adapted to vary a distance between the first electrode layer and the second electrode layer in response to pressing of the operation surface,
the displacement layer including a rubbery elastic body and including a plurality of columnar parts each stretchable in the pressing direction,
one or both of a surface of the first electrode layer facing the displacement layer and a surface of the second electrode layer facing the displacement layer being provided with a bonding layer that is configured of a rubbery elastic layer or a coating layer containing a silane compound,
the method comprising:
an easy adhesion treatment step of performing easy adhesion treatment on one or both of a surface of the bonding layer to be bonded to the columnar parts and surfaces of the columnar parts to be bonded to the bonding layer; and
a step of overlapping the bonding layer with the columnar parts to integrally bond the bonding layer to the columnar parts after the easy adhesion treatment step.

11. The detection sensor fabrication method of claim 10, wherein the easy adhesion treatment step is a step of performing the easy adhesion treatment intensively on the bonding surfaces of the columnar parts to be bonded to the bonding layer and/or the bonding surface of the bonding layer to be bonded to the columnar parts.

12. The detection sensor fabrication method of claim 11, wherein the easy adhesion treatment step is performed with use of a masking jig that exposes top surfaces of the columnar parts and/or a part or whole of the bonding surface of the bonding layer to be bonded to the top surfaces of the columnar parts.
